(19) United States
(12) Patent Application Publication
(10) Pub. No.: US 2008/0014885 A1
(43) Pub. Date: Jan. 17, 2008

(54) System and method for delivering mobile services

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Keren Dan Technologies, Tel-Aviv (IL)

(21) Appl. No.: 11/487,368

(22) Filed: Jul. 17, 2006

(51) Int. Cl. H04B 1/18

(52) U.S. Cl. 455/187.1

(57) ABSTRACT

A mobile terminal issues a signaling command such as a call divert message via the signaling link, along with a knowingly invalid number. The call divert request ends up being rejected by the caller's home operator due to the invalid number accompanying the call divert request. A communication server associated with the caller's mobile terminal receives the rejected request and knows how to interpret the invalid number as a service request. For example, the call divert request is to a number with a country prefix of 99 followed by a valid phone number. The communication server then interprets the request as a callback request to the valid phone number, wherein the number following the initial 99 is the destination number to call and connect with the mobile terminal.

### FIELD OF THE INVENTION

The present invention relates to a system and method for delivering services to a mobile terminal, and in particular to delivering mobile services to a roaming terminal via a callback mechanism.

### BACKGROUND OF THE INVENTION

Mobile phone charges can be quite steep when a subscriber is located outside the influence zone of the mobile phone operator's network to which he subscribes to. When a user travels, for example, to a different country, he may be able to use his mobile phone to originate and receive calls only if his original mobile phone operator has special agreements, known in the art as “roaming agreements”, to let its own users use a different network for initial connection.

For example, mobile phone user A subscribes to a mobile network Operator B. While A is traveling outside the territory where mobile Operator B is operating its mobile network, user A might be able to connect to mobile Operator C operating in said area, only if Operator B has commercial roaming agreements with Operator C. In this case, A would be allowed to use the C network to place and receive calls.

It happens, in many cases, that roaming charges for receiving and placing calls on a mobile phone while temporarily connected to a different network than the one the user has subscribed to, can be very high. Even in cases where a user does not pay for receiving calls on his mobile phone while in his home network—a commercial option known as calling party pays (CPP)—the user will usually be charged for receiving calls when roaming, since mobile Operator C has to be paid in addition to mobile Operator B.

When roaming, the difference between charges of incoming and outgoing calls can be very significant, sometimes at a ratio of 1:7 or even more. This situation has created opportunities for methods of communication where user A connects to user D, via a predetermined third party offering favorable commercial terms, and thus user A is not exposed to arbitrary and, in most cases, unknown roaming charges, and where some costs can be controlled and reduced significantly.

Another problem roamers face frequently is that they do not enjoy the same accesses to mobile services outside their home network. While within the home network, a subscriber may be accustomed to use short-code dialing for information services such as 411 for directory assistance or 123 for accessing his voicemail. While roaming, a dialed short-code is typically first interpreted by the local operator which may not recognize the short code. In a worse scenario, the same digit combination may lead to a different service adding to the confusion and frustration of the roaming user, and incurring him unnecessary expenses.

Callback is a well-known method in the industry for reducing outgoing call costs either when roaming or not. In a callback scheme, the caller typically calls a predetermined service number and is then immediate called back by the callback service. The caller needs to communicate the destination number he wishes to call and is then connected to that destination number. Since the destination number is called by the callback provider, the calling rates are known, and typically much lower than what the caller would pay in a direct dial call. One of the biggest challenges of the callback industry has been how to obtain the destination number from the caller. Some schemes ask the caller to punch in the number, which means the caller needs to either remember the number by heart or have it in front of him. A mobile user typically has many numbers in the mobile terminal memory, so they are not easily accessible during a call. Another method has the user dial the destination number while the actual call gets barred and the destination number is communicated via a Short Message (SMS). This method is easier for the caller since he dials out the destination number as if in a direct call, except that the user incurs the cost of an additional SMS message for every call attempt, even if the destination number is not available, busy or when the user mistakenly dialed a wrong number.

Accordingly, there is a strong need to enable roaming mobile phone users to not only control and reduce the costs of outgoing calls but also to enable them to access mobile services in the same manner as if in the home network. Additionally, there is also a strong need to provide a callback method which is easy to use by the caller and is cost-effective.

### SUMMARY OF THE INVENTION

The present invention relates to a method for offering mobile services to a roaming mobile phone user and a system implementing said method. The present invention benefits from the fact that most telephone networks establish a voice or data call using voice or data channels and an independent signaling channel. The caller is not billed for information exchanged on the signaling channel. Billing only occurs when an actual voice or data call is established on the remaining non-signaling channels.

The method of the invention consists of issuing a signaling command such as a call divert message via the signaling link, along with a knowingly invalid number. The call divert request ends up being rejected by the caller's home operator due to the invalid number accompanying the call divert request. A communication server of the invention associated with the caller's mobile terminal receives the rejected request and knows how to interpret the invalid number as a service request. In one embodiment of the present invention, the call divert request is to a number with a country prefix of 99 followed by a valid phone number. The communication server then interprets the request as a callback request to the valid phone number, wherein the number following the initial 99 is the destination number to call and connect with the mobile terminal.

### BRIEF DESCRIPTION OF THE DRAWINGS

FIG. 1 is an overview of a GSM (Global System for Mobile Communications) network as known in the art.

FIG. 2 is a block diagram of a roaming mobile terminal connecting to its home network, in which the home network includes a communication server used by the invention.

FIG. 3 shows a service number comprised of a dummy prefix and a service request code.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a method for offering mobile services to a roaming mobile phone user and a system implementing said method. A method is disclosed for delivering a service to a mobile terminal, wherein the mobile terminal contains software or hardware logic adapted to generate a service call to a communication server, the method comprising the steps of:
(i) the user of the mobile terminal dials out a destination number;
(ii) the adapted software or hardware logic on the mobile terminal intercepts the call and creates a service number consisting of a predefined dummy prefix and a service request code, wherein said service request code is based on the destination number;
(iii) the adapted software or hardware logic on the mobile terminal issues a signaling request with an associated service number;
(iv) the signaling request is transferred via a signaling channel for authorization;
(v) the signaling request is rejected;
(vi) the service number associated with the signaling request is received by the communication server; and
(vii) the communication server reads the service request code from the received service number, and performs the service associated with said service request code.

Most telephone networks employ a separate, dedicated signaling channel or link responsible for establishing and terminating calls. Additional links or channels are used exclusively for the transmission of voice or data. The most common signaling method today is known as Signaling System #7 (SS7). SS7 is also referred to as “Common Channel Signaling System 7” (CCSS7) in North America. In some European countries, specifically the United Kingdom, it is sometimes called C7 (CCITT number 7) and is also known as number 7 and CCIS7. SS7 provides a universal structure for telephony network signaling, messaging, interfacing, and network maintenance. It deals with establishment of a call, exchanging user information, call routing, different billing structures, and supports Intelligent Network (IN) services. ISDN is another common channel signaling method.

The term “mobile terminal” as referred to herein means any mobile device with telephony capabilities or that can be augmented with telephony capabilities. Examples include, but are not limited to: mobile phones, Personal Digital Assistants (PDA's), portable computers, portable media playing devices, portable game consoles and others.

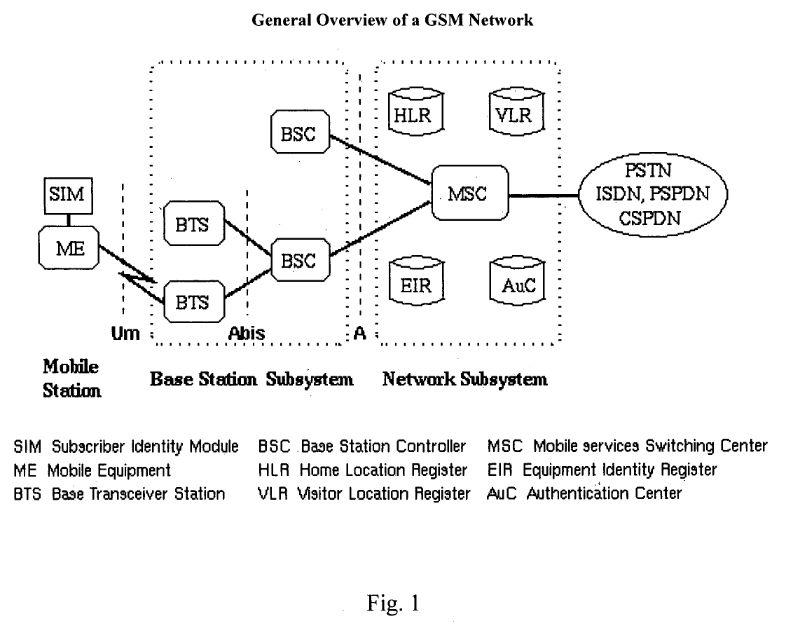

FIG. 1 is an overview of a generic GSM network of the art and its major components. The diagram and description below are available on the following Internet site: http://www.shoshin.uwaterloo.ca/˜jscouria/GSM/gsmreport.html. A GSM network is composed of several functional entities, whose functions and interfaces are specified. The GSM network can be divided into three broad parts. The Mobile Station is carried by the subscriber. The Base Station Subsystem controls the radio link with the Mobile Station. The Network Subsystem, the main part of which is the Mobile services Switching Center (MSC), performs the switching of calls between the mobile users, and between mobile and fixed network users. The MSC also handles the mobility management operations. Not shown is the Operations and Maintenance Center, which oversees the proper operation and setup of the network. The Mobile Station and the Base Station Subsystem communicate across the Um interface, also known as the air interface or radio link. The Base Station Subsystem communicates with the Mobile services Switching Center across the A interface.

The mobile station (MS) consists of the mobile equipment (the terminal) and a smart card called the Subscriber Identity Module (SIM). The SIM provides personal mobility, so that the user can have access to subscribed services irrespective of a specific terminal. By inserting the SIM card into another GSM terminal, the user is able to receive calls at that terminal, make calls from that terminal, and receive other subscribed services.

The mobile equipment is uniquely identified by the International Mobile Equipment Identity (IMEI). The SIM card contains the International Mobile Subscriber Identity (IMSI) used to identify the subscriber to the system, a secret key for authentication, and other information. The IMEI and the IMSI are independent, thereby allowing personal mobility. The SIM card may be protected against unauthorized use by a password or personal identity number.

The Base Station Subsystem is composed of two parts, the Base Transceiver Station (BTS) and the Base Station Controller (BSC). These communicate across the standardized Abis interface, allowing (as in the rest of the system) operation between components made by different suppliers.

The Base Transceiver Station houses the radio transceivers that define a cell and handles the radio-link protocols with the Mobile Station. In a large urban area, there will potentially be a large number of BTSs deployed, thus the requirements for a BTS are ruggedness, reliability, portability, and minimum cost.

The Base Station Controller manages the radio resources for one or more BTSs. It handles radio-channel setup, frequency hopping, and handovers. The BSC is the connection between the mobile station and the Mobile service Switching Center (MSC).

The central component of the Network Subsystem is the Mobile services Switching Center (MSC). It acts like a normal switching node of the PSTN or ISDN, and additionally provides all the functionality needed to handle a mobile subscriber, such as registration, authentication, location updating, handovers, and call routing to a roaming subscriber. These services are provided in conjunction with several functional entities, which together form the Network Subsystem. The MSC provides the connection to the fixed networks (such as the PSTN or ISDN). Signaling between functional entities in the Network Subsystem uses Signaling System Number 7 (SS7), used for trunk signaling in ISDN and widely used in current public networks.

The Home Location Register (HLR) and Visitor Location Register (VLR), together with the MSC, provide the call-routing and roaming capabilities of GSM. The HLR contains all the administrative information of each subscriber registered in the corresponding GSM network, along with the current location of the mobile. The location of the mobile is typically in the form of the signaling address of the VLR associated with the mobile station. There is logically one HLR per GSM network, although it may be implemented as a distributed database.

The Visitor Location Register (VLR) contains selected administrative information from the HLR, necessary for call control and provision of the subscribed services, for each mobile currently located in the geographical area controlled by the VLR. Although each functional entity can be implemented as an independent unit, all manufacturers of switching equipment to date implement the VLR together with the MSC, so that the geographical area controlled by the MSC corresponds to that controlled by the VLR, thus simplifying the signaling required. Note that the MSC contains no information about particular mobile stations—this information is stored in the location registers.

The other two registers are used for authentication and security purposes. The Equipment Identity Register (EIR) is a database that contains a list of all valid mobile equipment on the network, where each mobile station is identified by its International Mobile Equipment Identity (IMEI). An IMEI is marked as invalid if it has been reported stolen or is not type approved. The Authentication Center (AuC) is a protected database that stores a copy of the secret key stored in each subscriber's SIM card, which is used for authentication and encryption over the radio channel.

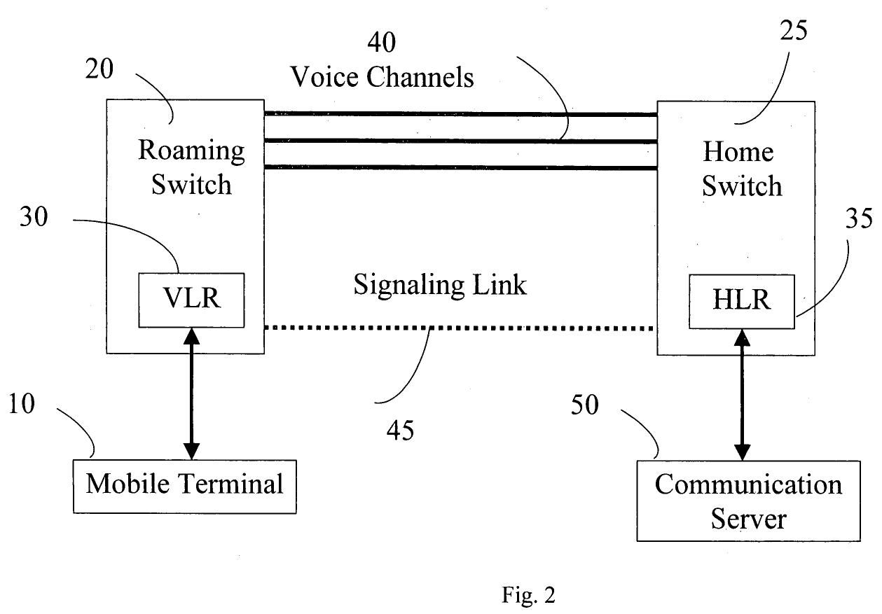

FIG. 2 is a block diagram of a roaming mobile terminal 10 connecting to its home network. When roaming, the mobile terminal 10 is connected to a different operator or service provider than its home provider. The home provider is defined as the service provider with which the user has a direct billing relationship and who authorizes the calls made by the mobile terminal 10. When attempting to establish a call, the mobile terminal 10 connects to the roaming network local switch, marked in FIG. 2 as roaming switch 20. When the mobile terminal 10 attempts to make a call, the roaming switch 20 contacts the home switch 25 for authorization. Information regarding the identity of the mobile terminal 10 and the nature of the request are passed from the Visitor Location Register (VLR) 30 of the roaming or visiting network to the home networks' Home Location Register (HLR) 35. The two networks, the roaming network and the home network are connected via voice channels 40 and a signaling link 45. A communication server 50 of the invention is associated with the HLR 35 for exchanging information.

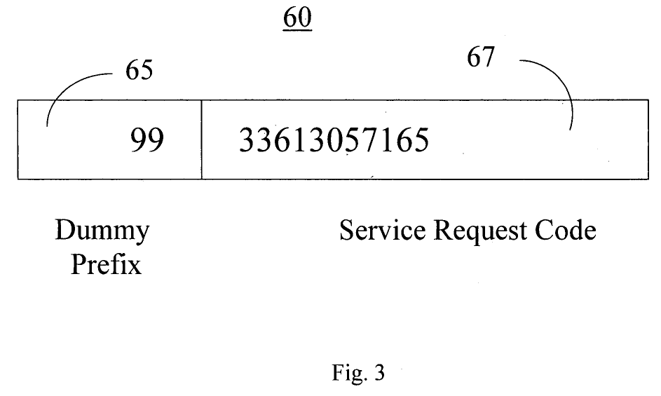

FIG. 3 shows a service number 60 comprised of a dummy prefix 65 and a service request code 67. In one embodiment of the present invention, the number 99 is used as the dummy prefix 65. The number 99 is a good choice for a dummy prefix 65 since it does not correspond to any country prefix. The service request code 67 example shown in FIG. 3 is a telephone number in France (country code 33).

The services provided by the invention to the mobile terminal 10 are based on the callback mechanism wherein the mobile terminal 10 gets called back within seconds and then connected to the desired phone number. The process starts when the user of the mobile terminal 10 dials a destination telephone number. Adapted software or hardware logic on the mobile terminal 10 intercepts the call, stores the destination number in a temporary storage location, and creates a service number 60. The service number 60 is composed of two parts: a dummy prefix 65 and a service request code 67. The dummy prefix 65 is usually a predetermined number, for example, 99 . The service request code 67 is based on the destination number dialed by the mobile terminal 10 and may also be identical to the destination number.

The adapted software or hardware logic on the mobile terminal 10 then proceeds to issue a signaling request with an associated service number 60. In one embodiment of the present invention the signaling request is a call divert request. A call divert request, sometimes also termed call forward request, is a request to transfer all incoming calls to a different phone number. For example, when traveling some people may wish to transfer all calls received to their home or office to their mobile phone. The signaling request along with the associated service number 60 are then transmitted via the signaling link 45 for authorization. The signaling request arrives to the HLR 35 for authorization. The signaling request will always end up being refused due to the dummy prefix 65 that is not a valid beginning of a valid phone number. In one embodiment of the present invention, the communication server 50 receives the signaling request and service number 60 from the HLR 35, and instructs the HLR to reject the signaling request. In another embodiment of the present invention, the communication server 50 instructs the HLR 35 to always reject signaling requests with service numbers 60 that start with a dummy prefix 65. After rejecting the signaling request, the HLR 35 forwards the communication server 50 the rejected signaling request and service number 60.

Once the communication server 50 receives rejected signaling request and service number 60 it looks at the service request code 67 and performs the service associated with that service request code 67. Examples of services the communication server 50 can perform include but are not limited to: callback, voicemail, short-code dialing, information services, data services or directory assistance.

In a callback service, the communication server 50 receives the destination number in the service request code 67. The communication server 50 then dials back the telephone number associated with the mobile terminal 10, followed by dialing the destination number, and then connects the mobile terminal 10 with the destination number.

If the service request code 67 is for voicemail, the communication server 50 then dials user's voicemail number, dials back the mobile terminal 10 and then connects the two.

If the service request code 67 is identified as a short-code, the communication server 50 retrieves the telephone number associated with the dialed short-code and then dials the retrieved phone number, dials back the mobile terminal 10 and then connects the two. Depending on the service requested by the user, the communication server 50 either retrieves a number from the roaming network or from the home network. If the user, for example, dials a short-code number for a taxi service, the communication server 50 will look up a taxi service in the area the user is roaming. If on the other hand, the user dials a short-code for a sports scores service, the communication server 50 will look up the sports news service in the user's home network.

Although the invention has been described in detail, nevertheless changes and modifications, which do not depart from the teachings of the present invention, will be evident to those skilled in the art. Such changes and modifications are deemed to come within the purview of the present invention and the appended claims.

1. A method for delivering a service to a mobile terminal, wherein the mobile terminal contains software or hardware logic adapted to generate a service call to a communication server, the method comprising the steps of:
(i) the user of the mobile terminal dials out a destination number;
(ii) the adapted software or hardware logic on the mobile terminal intercepts the call and creates a service number consisting of a predefined dummy prefix and a service request code, wherein said service request code is based on the destination number;
(iii) the adapted software or hardware logic on the mobile terminal issues a signaling request with an associated service number;
(iv) the signaling request is transferred via a signaling channel for authorization;
(v) the signaling request is rejected;
(vi) the service number associated with the signaling request is received by the communication server; and
(vii) the communication server reads the service request code from the received service number, and performs the service associated with said service request code.

2. A method according to claim 1, wherein the communication server dials a first number associated with the mobile terminal followed by dialing a second number associated with said service request code, and then connects the first number with the second number.

3. A method according to claim 1, wherein said service includes: callback, voicemail, short-code dialing, information services, data services and directory assistance.

4. A method according to claim 3, wherein said service is callback and said service request code is the destination number.

5. A method according to claim 1, wherein said signaling request is a call divert request asking to divert all calls received by the mobile terminal to said service number.

6. A method according to claim 1, wherein said signaling channel is a Common Channel Signaling method.

7. A method according to claim 6, wherein said Common Channel Signaling method is SS7 or ISDN.

8. A method according to claim 1, wherein said dummy prefix is 99.

9. A method according to claim 1, wherein said request is rejected by the HLR associated with said mobile terminal's home network.

10. A method according to claim 1, wherein said request is transferred by the HLR associated with said mobile terminal's home network to said communication server, and said communication server rejects the request.

11. A telephony system for delivering a service to a mobile terminal, wherein the mobile terminal contains software or hardware logic adapted to generate a service call to a communication server, and the interaction between said communication server and said mobile terminal is carried out by the following steps:
(i) the user of the mobile terminal dials out a destination number;
(ii) the adapted software or hardware logic on the mobile terminal intercepts the call and creates a service number consisting of a predefined dummy prefix and a service request code;
(iii) the adapted software or hardware logic on the mobile terminal issues a signaling request with an associated service number;
(iv) the signaling request is transferred via a signaling channel for authorization;
(v) the signaling request is rejected;
(vi) the service number associated with the signaling request is received by the communication server; and
(vii) the communication server reads the service request code from the received service number, and performs the service associated with said service request code.

12. A system according to claim 11, wherein the communication server dials a first number associated with the mobile terminal followed by dialing a second number associated with said service request code; and then connects the first number with the second number.

13. A system according to claim 11, wherein said service includes: callback, voicemail, short-code dialing, information services, data services and directory assistance.

14. A system according to claim 13, wherein said service is callback and said service request code is the destination number.

15. A system according to claim 11, wherein said signaling request is a call divert request asking to divert all calls received by the mobile terminal to said service number,

16. A system according to claim 11, wherein said signaling channel is a Common Channel Signaling method.

17. A system according to claim 16, wherein said Common Channel Signaling method is SS7 or ISDN.

18. A system according to claim 11, wherein said dummy prefix is 99.

19. A system according to claim 11, wherein said request is rejected by the HLR associated with said mobile terminal.

20. A system according to claim 11, wherein said request is transferred by the HLR associated with said mobile terminal's home network to said communication server, and said communication server rejects the request.

21. A method for delivering a service to a mobile terminal, wherein the mobile terminal contains software or hardware logic adapted to generate a service call to a communication server, the method comprising the steps of:
(i) the user of the mobile terminal dials out a destination number;
(ii) the adapted software or hardware logic on the mobile terminal intercepts the call and creates a service number consisting of a prefix of the number 99 and a service request code, wherein said service request code is based on the destination number;
(iii) the adapted software or hardware logic on the mobile terminal issues a call divert signaling request along with said associated service number;
(iv) the call divert signaling request is transferred for authorization via a signaling channel to the HLR associated with said mobile terminal;
(v) the signaling request is rejected by the HLR;
(vi) the service number associated with the call divert signaling request is received by the communication server; and
(vii) the communication server reads the service request code from the received service number, and performs the service associated with said service request code.
